(19) United States
(12) Patent Application Publication
(10) Pub. No.: US 2024/0379978 A1
(43) Pub. Date: Nov. 14, 2024

(54) Method and Device for Detecting an Impaired Fuel Cell

(71) Applicant: Bayerische Motoren Werke Aktiengesellschaft, Muenchen (DE)

(72) Inventors: Moritz WENZEL, Moenchengladbach (DE); Marco ZOESCH, Vaterstetten (DE)

(21) Appl. No.: 18/682,149

(22) PCT Filed: Aug. 2, 2022
(86) PCT No.: PCT/EP2022/071697

§ 371 Date: Feb. 8, 2024

(30) Foreign Application Priority Data
Aug. 9, 2021 (DE) 10 2021 120 586.7

(51) Int. Cl. H01M 8/04537; H01M 8/04298; H01M 8/04664; H01M 8/04992

(52) U.S. Cl. CPC H01M 8/04552; H01M 8/04305; H01M 8/04671; H01M 8/04992; H01M 2250/20

(57) ABSTRACT

A device for monitoring a fuel cell stack which has a first fuel cell and at least one fuel cell adjacent to the first fuel cell is described. The device is designed to determine a voltage measurement value of a voltage generated by the adjacent fuel cell. The device is further designed to detect or to predict impairment of the first fuel cell on the basis of the determined voltage measurement value of the voltage generated by the adjacent fuel cell.

### BACKGROUND AND SUMMARY

The technology disclosed herein relates to a method and to a corresponding device for detecting an impaired fuel cell in a fuel cell stack.

A motor vehicle may comprise a fuel cell system having a fuel cell stack with a plurality of fuel cells, wherein the fuel cell system generates electrical energy for the operation, in particular for the driving, of the vehicle on the basis of a fuel such as hydrogen for example.

The voltage of the individual fuel cells is typically monitored in order to ensure the safety of the fuel cell stack. If an impairment of the cell voltage (e.g., a negative cell voltage or a cell voltage smaller than a predefined voltage threshold value) is identified for a fuel cell, the deactivation of the entire fuel cell stack can be brought about as a protective measure. Analogously, a deactivation of the entire fuel cell stack can also be brought about for safety reasons in the case of a non-presence of a voltage measurement value for an individual fuel cell (e.g., on account of a measuring module outage), even if there is in fact no impairment of the individual fuel cell.

The availability of the fuel cell system and hence of the vehicle is impaired by such a safety shutdown on account of a non-present voltage measurement value.

It is a preferred object of the technology disclosed herein to reduce or rectify at least one disadvantage of a solution known in advance or to propose an alternative solution. In particular it is a preferred object of the technology disclosed herein to efficiently and reliably increase the availability of a fuel cell system. Further preferred objects may arise from the advantageous effects of the technology disclosed herein. The objects are each achieved by the subject matter of the independent claims. The dependent claims disclose preferred embodiments.

According to one aspect, a device for monitoring a fuel cell stack is described, wherein the fuel cell stack contains a first fuel cell and at least one fuel cell adjacent (optionally directly) thereto. Typically, the fuel cell stack contains a plurality of fuel cells (e.g., 100 or more, or 200 or more). The fuel cell stack can be operated in a vehicle in order to generate electrical energy for the operation of an electric drive motor of the vehicle.

The device is configured to ascertain a voltage measurement value of the voltage generated by the adjacent fuel cell. A voltage measuring module can be used to this end. The adjacent fuel cell can be arranged directly at the edge of the first fuel cell and can thus be referred to as an edge cell of the first fuel cell.

The device is further configured to detect or predict an impairment of the first fuel cell on the basis of the ascertained voltage measurement value of the voltage generated by the adjacent fuel cell. To this end, the voltage measurement value can be compared with an (optionally machine-learned) voltage threshold value. In particular, it is possible to ascertain whether the voltage measurement value is greater than or less than the voltage threshold value. Should it be ascertained that the voltage measurement value of the voltage generated by the adjacent fuel cell is less than the voltage threshold value, then it is optionally possible to deduce that an impairment of the first fuel cell is present or will be present. Should it be ascertained that the voltage measurement value of the voltage generated by the adjacent fuel cell is greater than the voltage threshold value, then it is optionally possible to deduce that no impairment of the first fuel cell is present or will be present.

In other words, the device can be configured to compare the ascertained voltage measurement value of the voltage generated by the adjacent fuel cell with a voltage threshold value, in particular a machine-learned voltage threshold value. Then, the comparison can be used as a basis to determine particularly precisely and robustly whether an impairment of the first fuel cell is present or will be present (or whether alternatively an impairment of the measuring module of the first fuel cell is present).

The voltage measurement value of the voltage generated by an adjacent fuel cell can thus be used to efficiently and reliably recognize or predict an impairment of a first fuel cell.

The device can be configured to bring about a protective measure for protecting the fuel cell stack if, in particular only if there was a detection or prediction of an impairment of the first fuel cell being present or being present in future. For example, the deactivation of the entire fuel cell stack can be brought about as protective measure. Thus, a safe operation of the fuel cell stack can be brought about efficiently.

The device can be configured to use the voltage measurement value of the voltage generated by the adjacent fuel cell as a basis for determining whether an impairment of the first fuel cell is present or will be present, or whether (alternatively) an impairment of the measuring module for ascertaining a voltage measurement value of the voltage generated by the first fuel cell is present. Should it be determined that an impairment of the measuring module of the first fuel cell (and no impairment of the first fuel cell) is present, it is possible to dispense with the bringing about of a protective measure for protecting the fuel cell stack. In particular, the operation of the fuel cell stack can be continued. Thus, the availability of the fuel cell stack can be increased safely and efficiently.

The fuel cell stack may contain a plurality of adjacent fuel cells which are adjacent to the first fuel cell (optionally on different sides). The device can be configured to ascertain a plurality of voltage measurement values of the voltage generated in each case by the corresponding plurality of adjacent fuel cells. To this end, use can be made of measuring modules for the individual adjacent fuel cells.

Moreover, the device can be configured to detect or predict an impairment of the first fuel cell on the basis of the plurality of ascertained voltage measurement values. In this case, the individual voltage measurement values can each be compared with an (optionally machine-learned) voltage threshold value. By considering voltage measurement values for a plurality of different adjacent fuel cells, it is possible to further increase the reliability of the recognition of an impairment of the first fuel cell.

The device can be configured to detect or predict an impairment of the first fuel cell without using a voltage measurement value for the voltage generated by the first fuel cell. In other words, it is possible to recognize purely on the basis of the voltage measurement values for one or more adjacent fuel cells whether an impairment of the first fuel cell (or alternatively an impairment of the measurement module of the first fuel cell) is present.

As stated further above, the fuel cell stack typically comprises a plurality of fuel cells. The device can be configured to ascertain a voltage measurement series with a plurality of voltage measurement values for the corresponding plurality of fuel cells. In this case, the voltage measurement series may optionally include a voltage measurement value for the first fuel cell. An impairment of the first fuel cell can then be detected or predicted particularly precisely and robustly, in particular by using a pattern recognition algorithm, on the basis of the voltage measurement series.

The device can be configured to detect or predict an impairment of the first fuel cell by way of a machine-learned decision unit on the basis of the ascertained voltage measurement value or on the basis of the ascertained voltage measurement values. In this case, the decision unit can comprise a decision tree with machine-learned decision criteria (in particular with voltage threshold values). The decision unit, in particular the decision tree, can be trained using training data. This can enable particularly efficient and reliable monitoring of the fuel cell stack.

A further aspect describes a fuel cell system comprising the device described in this disclosure.

A further aspect describes a (road-based) motor vehicle (in particular an automobile or a truck or a bus or a motorcycle) comprising the device described in this document and/or the fuel cell system described in this document.

A further aspect describes a method for monitoring a fuel cell stack containing a first fuel cell and at least one fuel cell adjacent (optionally directly contiguous) thereto. The method comprises the ascertainment of a voltage measurement value of the voltage generated by the adjacent fuel cell. The method also comprises the detection or prediction of an impairment (e.g., an undersupply and/or a defect) of the first fuel cell on the basis of the ascertained voltage measurement value of the voltage generated by the adjacent fuel cell.

A further aspect describes a software (SW) program. The SW program can be configured to be executed on a processor (e.g., on a controller of a vehicle) in order to thereby carry out the method described in this disclosure.

A further aspect describes a storage medium. The storage medium may comprise a SW program which is configured to be executed on a processor in order to thereby carry out the method described in this disclosure.

It should be observed that the methods, devices, and systems described in this disclosure can be used both on their own and in combination with other methods, devices, and systems described in this document. Moreover, all aspects of the methods, devices, and systems described in this document can be combined with one another in a wide variety of ways. In particular, the features of the claims can be combined with one another in a wide variety of ways. Further, features listed in parentheses should be understood to be optional features.

### BRIEF DESCRIPTION OF THE DRAWINGS

The technology will be described in detail below on the basis of exemplary embodiments. In the drawings:

FIG. 1 shows an exemplary fuel cell system with a fuel cell stack;

FIG. 2A shows a side view of an exemplary fuel cell stack;

FIG. 2B shows an exemplary voltage measurement series for a fuel cell stack;

FIG. 3 shows a flowchart of an exemplary method for detecting and/or for predicting an impairment of a fuel cell stack.

### DETAILED DESCRIPTION OF THE DRAWINGS

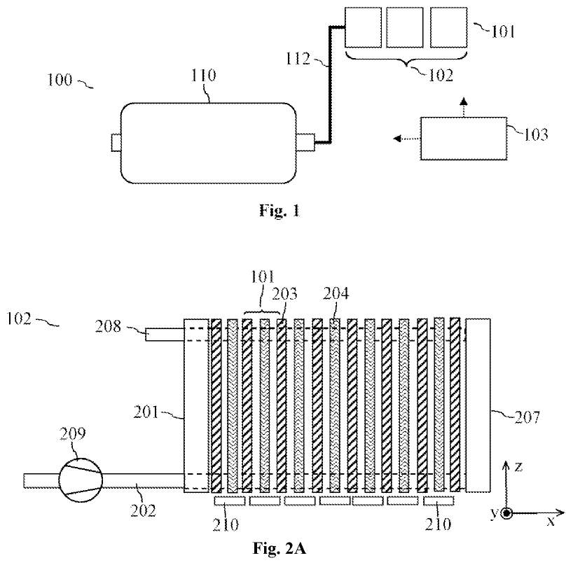

As stated at the outset, the present disclosure addresses the problem of efficiently and reliably increasing the availability of a fuel cell system. In this context, FIG. 1 shows a fuel cell system 100 having a fuel cell stack 102 with a plurality of fuel cells 101. The fuel cell system 100 is designed, for example, for mobile applications such as motor vehicles, in particular for providing the electrical energy for at least one electrical engine for moving a motor vehicle. A fuel cell 101 is an electrochemical energy converter which converts fuel (in particular H₂) and oxidants into reaction products and produces electricity and heat in the process. Moreover, the fuel cell system 100 typically comprises at least one pressure tank 110, which can be used to provide the fuel for the fuel cells 101. The pressure tank 110 is connected to the one or more fuel cells 101 by lines 112.

A fuel cell 100 comprises an anode and a cathode, which are separated by an ion-selective or ion-permeable separator. The anode is supplied with fuel. Preferred fuels are: hydrogen, low-molecular-weight alcohol, biofuels or liquefied natural gas. The cathode is supplied with oxidant. Preferred oxidants are: air, oxygen and peroxides. The ion-selective separator may for example be in the form of a proton exchange membrane (PEM). Use is preferably made of a cation-selective polymer electrolyte membrane. Materials for such a membrane are for example: Nafion®, Flemion® and Aciplex®.

As a rule, the fuel cells 101 of the fuel cell stack 102 each comprise two separator plates. The ion-selective separator of a fuel cell 101 is generally arranged between two separator plates in each case. The one separator plate forms the anode together with the ion-selective separator. The further separator plate arranged on the opposite side of the ion-selective separator however forms the cathode together with the ion-selective separator. Gas channels for fuel or for oxidants are preferably provided in the separator plates. Moreover, coolant channels for a coolant serving to cool the fuel cells 101 can be provided in the separator plates.

The separator plates can be in the form of monopolar plates or in the form of bipolar plates. In particular, a bipolar plate has two sides in this case, wherein the one side forms the anode of a first fuel cell 101 together with an ion-selective separator and the second side forms the cathode of an adjacent second fuel cell 101 together with a further ion-selective separator of the second fuel cell 101.

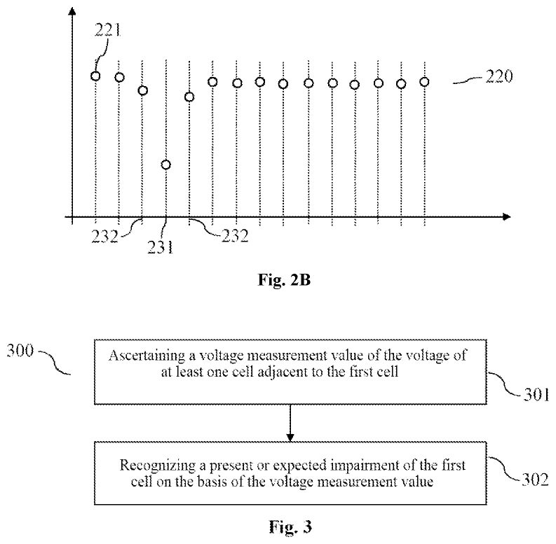

FIG. 2A shows the structure of an exemplary fuel cell stack 102 in a side view (along the x-axis of a Cartesian coordinate system). The fuel cell stack 102 comprises end plates 201, 207, between which a plurality of fuel cells 101 are arranged. The end plates 201, 207 can be used to keep together or press together the fuel cells 101 of the fuel cell stack 102. As stated above, a fuel cell 101 can be formed by a respective side of two adjacent bipolar plates 203. A membrane electrode assembly (MEA) 204 can be arranged between two adjacent bipolar plates 203. Moreover, the fuel cell stack 102 comprises a fuel channel 208 and/or an oxidant channel 202, through which fuel and oxidant, respectively, can be guided via the bipolar plates 203 to the individual fuel cells 101. In the process, the oxidant can be conveyed in the oxidant channel 202 by an oxidant conveyor 209 (e.g., by a compressor). Moreover, the fuel cell stack 102 comprises one or more channels, by way of which one or more reaction products can be removed (once again via the bipolar plates 203) from the individual fuel cells 101.

The fuel cell stack 102 typically comprises a plurality of measuring modules 210 for the corresponding plurality of fuel cells 101. The measuring module 210 for a fuel cell 101 can be configured to acquire voltage information, in particular a voltage measurement value, in relation to the voltage generated by the fuel cell 101.

A (control) device 103 of the fuel cell system 100 can be configured to ascertain, by way of the plurality of measuring modules 210, a corresponding plurality of measurement values of the voltages of the corresponding plurality of fuel cells 101. FIG. 2B shows an exemplary voltage measurement series 220 with a plurality of voltage measurement values 221 for the corresponding plurality of fuel cells 101 of the fuel cell stack 102. In this case, a respective voltage measurement value 221 can be provided for the individual fuel cells 231, 232.

In the example depicted in FIG. 2B, a first fuel cell 231 has a reduced measurement value 221. This is an indication that the first fuel cell 231 is impaired (e.g., on account of an undersupply with fuel and/or oxidant or on account of a defect). The (control) device 103 can be configured to cause the fuel cell system 100 to be deactivated if an impaired fuel cell 231 is detected on the basis of the voltage measurement series 220.

The situation may arise in which the measuring module 210 for the first fuel cell 231 has a defect, and as a consequence thereof indicates an incorrect, especially a reduced, voltage measurement value 221, or even no voltage measurement value at all, for the first fuel cell 231. This has the effect that the fuel cell system 100 is deactivated even though the first fuel cell 231 does not have an impairment. A defective measuring module 210 can therefore lead to a reduced availability of the fuel cell system 100.

As emerges from FIG. 2B, an impaired first fuel cell 231 typically has effects on the voltage measurement values 221 of the one or more (directly) adjacent fuel cells 232. In particular, it is evident from FIG. 2B that the voltage measurement values 221 of the one or more (directly) adjacent fuel cells 232 are also reduced if the first fuel cell 231 has a defect. Then again, the voltage measurement values 221 of the one or more (directly) adjacent fuel cells 232 are typically not reduced if the first fuel cell 231 does not have a defect.

This effect can be used to differentiate a first situation, in which the reduced voltage measurement value 221 of the first fuel cell 231 can be traced back to a defect of the first fuel cell 231, from a second situation, in which the reduced voltage measurement value 221 of the first fuel cell 231 can be traced back to a defect of the measuring module 210 of the first fuel cell 231. The fuel cell system 100 need not be deactivated when the second situation is present, and so the availability of the fuel cell system 100 can be increased.

Thus, it is possible to observe that the voltage level of the adjacent cells 232 of a critical cell 231 likewise reduces over time. This relationship can be used to be able to make a reliable statement about the state of an individual cell 231 even without the data 221 from this cell 231. In particular, it is possible to analyze the pattern of a voltage measurement series 220 in order to determine whether or not a fuel cell stack 102 contains an impaired cell 231. To this end, a recognition unit can be machine-trained on the basis of training data. The recognition unit can for example comprise a decision tree (with one or more voltage threshold values). In the process, it is possible within the scope of the decision tree to define, in particular train, criteria (in particular threshold values) which allow a decision to be made on the basis of the adjacent cells 232 as to whether or not a cell 231 is in a critical state. A decision tree can typically be implemented in resource-efficient fashion on a microcontroller of the (control) device 103.

Thus, an assessment mechanism is described, which checks the adjacent cells 232 of a cell 231 on the basis of defined criteria. If the criteria resonate and/or are fulfilled, then an assumption can be made that the corresponding cell 231 is impaired.

In an exemplary case, a cell 231 does not optionally have a (reliable) measurement value 221 available. Using the assessment mechanism described, it is possible by way of the decision unit to check whether or not the cell 231 is in fact damaged and/or undersupplied. In a further example, measurement values 221 may be available for all cells 231, 232. Then, for example by considering the cell 231 with the smallest measurement value 221, it is possible to recognize and/or predict, possibly in timely fashion, damage to and/or undersupply for this cell 231. The assessment mechanism and the criteria for recognizing an impaired cell 231 may have been ascertained in advance by way of an automated validation of a plurality of data.

FIG. 3 shows a flowchart of an (optionally computer-implemented) method 300 for monitoring a fuel cell stack 102 containing a first fuel cell 231 and at least one fuel cell 232 adjacent thereto. A fuel cell stack 102 typically includes a plurality of fuel cells 101, 231, 232 (e.g., 100 or more, or 200 or more fuel cells 101, 231, 232).

The method 300 comprises the ascertainment 301 of a voltage measurement value 232 of the voltage generated by the (optionally directly) adjacent fuel cell 232. A voltage measuring module 210 of the adjacent fuel cell 232 can be used to this end. It may be the case that no voltage measurement value 231 can be ascertained for the first fuel cell 231 (e.g., on account of a defect in the measuring module 210 for the first fuel cell 231). It may be the case that only a relatively low voltage measurement value 231 can be ascertained for the voltage generated by the first fuel cell 231 (which may be caused for example by an impaired first fuel cell 231 or by an impaired measuring module 210).

Moreover, the method 300 comprises the detection or prediction 302 of an impairment of the first fuel cell 231 on the basis of the ascertained voltage measurement value 232 of the voltage generated by the adjacent fuel cell 232. Thus, the voltage measurement of a directly adjacent fuel cell 232 can be used to efficiently and reliably recognize whether or not the first fuel cell 231 is in fact impaired. This makes it possible to avoid an incorrect recognition of an impairment of the first fuel cell 231 efficiently and reliably.

The measures described in this disclosure allow an impairment of a fuel cell 231 of a fuel cell stack 102 to be efficiently and reliably recognized and/or predicted (or possibly excluded). This can increase the availability of the fuel cell stack 102.

The present invention is not limited to the exemplary embodiments shown. In particular, it should be observed that the description and the figures are only intended to elucidate the principle of the proposed methods, devices, and systems by way of example.

### LIST OF REFERENCE SIGNS

100 Fuel cell system
101 Fuel cell
102 Fuel cell stack
103 (Control) device
110 Pressure tank
112 Line (fuel)
201 End plate (facing the line)
202 Line (oxidant)
203 Bipolar plate
204 Electrode-membrane unit
207 End plate (facing away from the line)
208 Line (fuel)
209 Oxidant conveyor
210 Measuring module
220 Measurement series
221 Measurement value
231 Considered (first) fuel cell
232 Adjacent fuel cell
300 Method for monitoring a fuel cell stack
301-302 Method steps

1-10. (canceled)

11. A device for monitoring a fuel cell stack containing a first fuel cell and a fuel cell adjacent thereto, the device being configured:
to ascertain a voltage measurement value of a voltage generated by the adjacent fuel cell; and
to detect or predict an impairment of the first fuel cell on the basis of the ascertained voltage measurement value of the voltage generated by the adjacent fuel cell.

12. The device according to claim 11, wherein
the fuel cell stack contains a plurality of adjacent fuel cells adjacent to the first fuel cell; and
the device is configured:
to ascertain a plurality of voltage measurement values of the voltage generated by each adjacent fuel cell in the corresponding plurality of adjacent fuel cells; and
to detect or predict an impairment of the first fuel cell on the basis of the plurality of ascertained voltage measurement values.

13. The device according to claim 11, wherein the device is configured to detect or predict an impairment of the first fuel cell using a machine-learned decision unit on the basis of the ascertained voltage measurement value.

14. The device according to claim 13, wherein the decision unit comprises a decision tree with machine-learned decision criteria.

15. The device according to claim 11, wherein the device is configured to detect or predict an impairment of the first fuel cell without using a voltage measurement value for a voltage generated by the first fuel cell.

16. The device according to claim 11, wherein the device is configured to use the voltage measurement value of the voltage generated by the adjacent fuel cell as a basis to determine whether
or not an impairment of the first fuel cell is present; or
an impairment of a measuring module for ascertaining a voltage measurement value of the voltage generated by the first fuel cell is present.

17. The device according to claim 11, wherein the device is configured:
to compare the ascertained voltage measurement value of the voltage generated by the adjacent fuel cell with a machine-learned voltage threshold value; and
to determine on the basis of the comparison whether an impairment of the first fuel cell is present or will be present.

18. The device according to claim 11, wherein
the fuel cell stack comprises a plurality of fuel cells; and
the device is configured:
to ascertain a voltage measurement series with a plurality of voltage measurement values for the corresponding plurality of fuel cells; and
to detect or predict an impairment of the first fuel cell on the basis of the voltage measurement series by using a pattern recognition algorithm.

19. The device according to claim 11, wherein the device is configured to bring about a protective measure for protecting the fuel cell stack only if there was a detection or a prediction of an impairment of the first fuel cell being present or being present in future.

20. A method for monitoring a fuel cell stack containing a first fuel cell and a fuel cell adjacent thereto, the method comprising:
ascertaining a voltage measurement value of a voltage generated by the adjacent fuel cell; and
detecting or predicting an impairment of the first fuel cell on the basis of the ascertained voltage measurement value of the voltage generated by the adjacent fuel cell.

21. The method according to claim 20, wherein
the fuel cell stack contains a plurality of adjacent fuel cells adjacent to the first fuel cell; and
further comprising:
ascertaining a plurality of voltage measurement values of the voltage generated by each adjacent fuel cell in the corresponding plurality of adjacent fuel cells; and
detecting or predicting an impairment of the first fuel cell on the basis of the plurality of ascertained voltage measurement values.

22. The method according to claim 20, further comprising:
detecting or predicting an impairment of the first fuel cell using a machine-learned decision unit on the basis of the ascertained voltage measurement value.

23. The method according to claim 22, wherein the decision unit comprises a decision tree with machine-learned decision criteria.

24. The method according to claim 20, further comprising:
detecting or predicting an impairment of the first fuel cell without using a voltage measurement value for a voltage generated by the first fuel cell.

25. The method according to claim 20, further comprising:
using the voltage measurement value of the voltage generated by the adjacent fuel cell as a basis to determine whether
or not an impairment of the first fuel cell is present; or
an impairment of a measuring module for ascertaining a voltage measurement value of the voltage generated by the first fuel cell is present.

26. The method according to claim 20, further comprising:
comparing the ascertained voltage measurement value of the voltage generated by the adjacent fuel cell with a machine-learned voltage threshold value; and
determining, on the basis of the comparison, whether an impairment of the first fuel cell is present or will be present.

27. The method according to claim 20, wherein
the fuel cell stack comprises a plurality of fuel cells; and
further comprising:
ascertaining a voltage measurement series with a plurality of voltage measurement values for the corresponding plurality of fuel cells; and
detecting or predicting an impairment of the first fuel cell on the basis of the voltage measurement series by using a pattern recognition algorithm.

28. The method according to claim 20, further comprising:
introducing a protective measure for protecting the fuel cell stack only if there was a detection or a prediction of the impairment of the first fuel cell being present or being present in future.
